(19) United States
(12) Patent Application Publication
(10) Pub. No.: US 2013/0210431 A1
(43) Pub. Date: Aug. 15, 2013

(54) RADIO BASE STATION APPARATUS AND TRANSMISSION POWER CONTROL METHOD

(71) Applicants: Tetsushi Abe, Tokyo (JP); Nobuhiko Miki, Tokyo (JP)

(72) Inventors: Tetsushi Abe, Tokyo (JP); Nobuhiko Miki, Tokyo (JP)

(73) Assignee: NTT DOCOMO, INC., Tokyo (JP)

(21) Appl. No.: 13/813,664

(22) PCT Filed: Aug. 1, 2011
(86) PCT No.: PCT/JP2011/067584

§ 371 Date: Mar. 20, 2013

(30) Foreign Application Priority Data
Aug. 3, 2010 (JP) 2010-174372

(51) Int. Cl. H04W 52/24

(52) U.S. Cl. CPC H04W 52/241
USPC 455/435.1

(57) ABSTRACT

With this transmission power control method, in a radio base station apparatus (10) of a macro cell, registration information as to whether or not a mobile terminal apparatus is a non-member mobile terminal apparatus, which is not a mobile terminal apparatus having registered access to a radio base station apparatus (20) of a femto cell, a received quality measurement result, and cell information, are received, whether or not a non-member mobile terminal apparatus has come near the femto cell is determined from the registration information, the received quality measurement result, and the cell information, and neighbor information, which indicates that a non-member mobile terminal apparatus has come near the femto cell, is reported to the radio base station apparatus (20) of the femto cell, by a backhaul link, and in the radio base station apparatus (20) of the femto cell, transmission power is reduced based on the neighbor information.

### TECHNICAL FIELD

The present invention relates to a radio base station apparatus and a transmission power control method in a next-generation mobile communication system.

### BACKGROUND ART

In 3GPP (3rd Generation Partnership Project), the standardization of LTE-Advanced (LTE-A) is in progress, as a fourth-generation mobile communication system to realize communication of further increased speed and increased volume from LTE (Long Term Evolution), which is an enhanced standard of the third-generation mobile communication system. In the LTE-A system, a heterogeneous network (hereinafter referred to as “HetNet”) configuration, which places significance on the local area environment, is under study. HetNet is a layered network, which overlays cells of various forms such as pico cells, femto cells and relays (small cell), in addition to the conventional macro cell, as shown in FIG. 1.

FIG. 2 is a diagram showing the relationship between downlink received power and path loss, when a pico base station where the transmission power is Δ smaller, neighbors a macro base station, in this HetNet. In FIG. 2, the solid lines show the downlink received power of each base station, and the broken lines show the reciprocal of path loss. Generally, from the perspective of the transmission path, on the downlink, the cell where the downlink received power is the maximum is an optimal cell, and, on the uplink, the cell where the path loss is the minimum is an optimal cell. When the transmission power is equal between neighboring base stations, the uplink and the downlink have a matching optimal cell, but, when the transmission power is different, the uplink and the downlink generally have different optimal cells. In the area of diagonal lines in FIG. 2, it is optimal to connect to the macro base station on the downlink, but, on the uplink, it is optimal to connect to the pico base station. In this way, in HetNet, the phenomenon occurs where, due to unequal cell coverage, optimal connecting cells differ between the uplink and the downlink.

A femto cell is a super-small cell that is directed to being provided in, for example, houses, small shops, and so on. In this femto cell, as shown in FIG. 3, it is possible to provide high-speed communication unceasingly, by the CSG (Closed Subscriber Group) function to limit access only to mobile terminal apparatuses (CSG-member UEs (User Equipment)) that are registered in advance. Consequently, even when a mobile terminal apparatus that is not registered (“non-CSG member UE”) is located near the radio base station apparatus (CSG femto BS) of the femto cell, the mobile terminal apparatus cannot access the femto cell. Consequently, for the non-CSG member UE, the CSG base station that is present nearby becomes a source of severe interference.

To solve this problem, in 3GPP, a method whereby the CSG femto BS measures the received power from the radio base station apparatus (macro BS) of the macro cell, and determines the transmission power on the downlink according to this power, is proposed (non-patent literature 1). To be more specific, as shown in FIG. 4A, when the femto BS is close to the macro BS and the received power from the macro BS measured by the femto BS is large, the transmission power from the femto BS is increased, and, as shown in FIG. 4B, when the femto BS is far (cell edge) from the macro BS and the received power from the macro BS is small, the transmission power from the femto BS is decreased.

With this method, even when there is no non-CSG member UE in the femto cell, transmission power is decreased, unnecessarily. To solve this problem, a method to decrease the transmission power only when a non-CSG member UE is detected is proposed. To be more specific, regardless of whether the femto BS is close to the macro BS as shown in FIG. 5A, or the femto BS is far from the macro BS as shown in FIG. 5C, when a non-CSG member UE is detected, as shown in FIG. 5B and FIG. 5D, the transmission power from the femto BS is reduced.

### CITATION LIST

### Non-Patent Literature

Non-Patent Literature 1: 3GPP, TR 36.921

### SUMMARY OF THE INVENTION

### Technical Problem

However, with the above method, it is necessary to constantly detect whether or not a non-CSG member UE is in the cell. In the femto cell, it is difficult to detect whether or not a non-CSG member UE is in the cell, and therefore it is necessary to detect whether or not a non-CSG member UE is in the cell in the macro cell and report this information to the femto cell. In this way, with the above method, in the femto cell, it is necessary to constantly keep detecting whether or not a non-CSG member UE is in the cell, and this requires additional control.

The present invention has been made in view of the above, and it is therefore an object of the present invention to provide a radio base station apparatus and a transmission power control method whereby transmission power is not unnecessarily reduced when there is no CSG non-member UE in a femto cell, and, furthermore, in the femto cell, it is possible to reduce interference of a CSG non-member mobile terminal apparatus without constantly detecting whether or not a CSG non-member UE is in the cell.

### Solution to Problem

A radio base station apparatus according to the present invention is a radio base station apparatus of a macro cell in a heterogeneous network including the macro cell and a femto cell, and the radio base station apparatus has a receiving section that receives registration information as to whether or not a mobile terminal apparatus is a non-member mobile terminal apparatus, which is not a mobile terminal apparatus having registered access to a radio base station apparatus of the femto cell, a received quality measurement result, and cell information, a determining section that determines whether or not the non-member mobile terminal apparatus has come near the femto cell from the registration information, the received quality measurement result, and the cell information, and a reporting section that reports neighbor information, which indicates that the non-member mobile terminal apparatus has come near the femto cell, to the radio base station apparatus of the femto cell, by a backhaul link.

A radio base station apparatus according to the present invention is a radio base station apparatus of a femto cell in a heterogeneous network including a macro cell and the femto cell, and the radio base station apparatus has a transmission power control section that, when receiving neighbor information which indicates that a non-member mobile terminal apparatus, which is not a mobile terminal apparatus having registered access to the radio base station apparatus of the femto cell, from a radio base station apparatus of the macro cell, reduces transmission power of the transmission signal based on the neighbor information.

A transmission power control method according to the present invention is a transmission power control method in a heterogeneous network including a macro cell and a femto cell, and the transmission power control method includes the steps of: in a radio base station apparatus of the macro cell: receiving registration information as to whether or not a mobile terminal apparatus is a non-member mobile terminal apparatus, which is not a mobile terminal apparatus having registered access to a radio base station apparatus of the femto cell, a received quality measurement result, and cell information, determining whether or not the non-member mobile terminal apparatus has come near the femto cell from the registration information, the received quality measurement result, and the cell information, and reporting neighbor information, which indicates that the non-member mobile terminal apparatus has come near the femto cell, to the radio base station apparatus of the femto cell, by a backhaul link; and, in the radio base station apparatus of the femto cell, reducing transmission power of the transmission signal based on the neighbor information.

### Technical Advantages of the Invention

According to the present invention, the radio base station apparatus of a macro cell receives registration information as to whether or not a mobile terminal apparatus is a non-member mobile terminal apparatus, which is not a mobile terminal apparatus having registered access to the radio base station apparatus of a femto cell, the received quality measurement result, and cell information, determines whether or not a non-member mobile terminal apparatus has come near the femto cell from the registration information, the received quality measurement result, and the cell information, and reports neighbor information, which indicates that a non-member mobile terminal apparatus has come near the femto cell, to the radio base station apparatus of the femto cell by a backhaul link, and the radio base station apparatus of the femto cell reduces the transmission power based on the neighbor information, so that transmission power is not reduced unnecessarily when there is no non-CSG member UE in the femto cell, and, furthermore, in the femto cell, it is possible to reduce interference of a non-CSG member mobile terminal apparatus without constantly detecting whether or not a non-CSG member UE is in the cell.

### BRIEF DESCRIPTION OF THE DRAWINGS

FIG. 1 is a diagram for explaining a heterogeneous network;

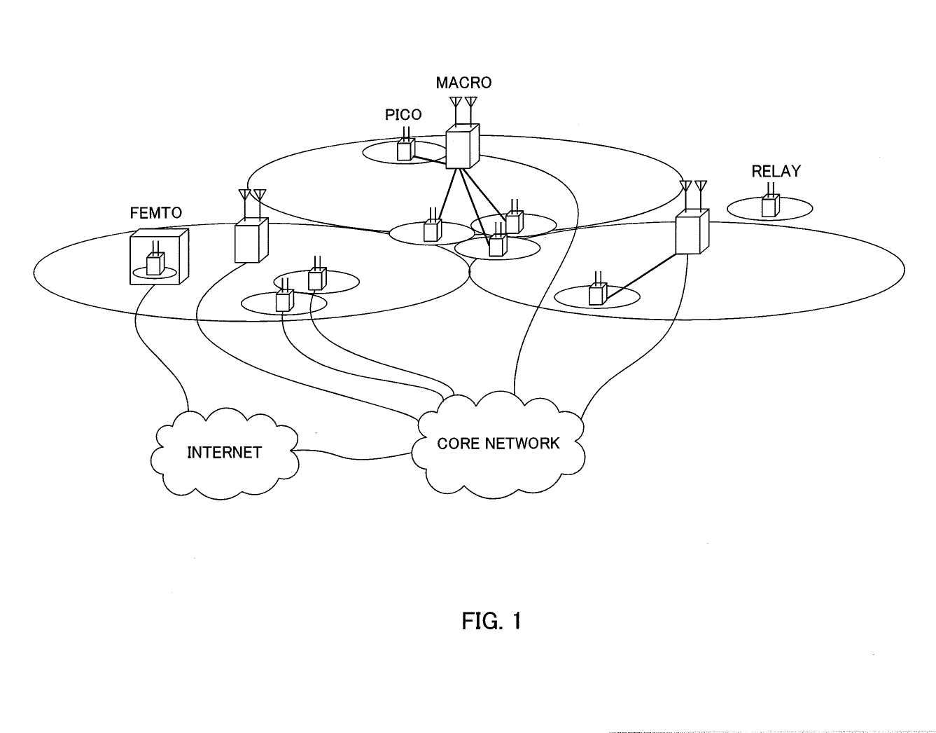

FIG. 2 is a diagram for explaining problems that occur in a heterogeneous network;

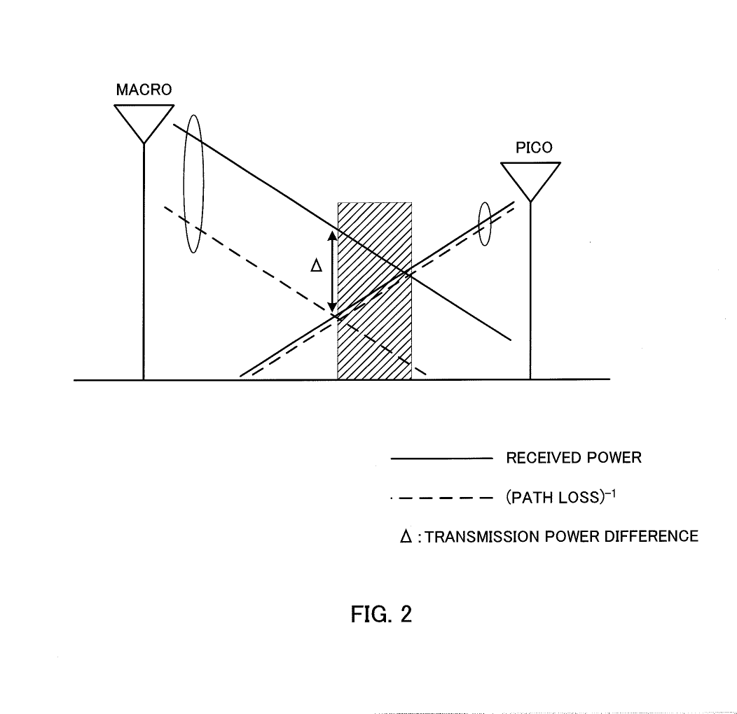

FIG. 3 is a diagram for explaining interference of a non-CSG member UE in a femto cell;

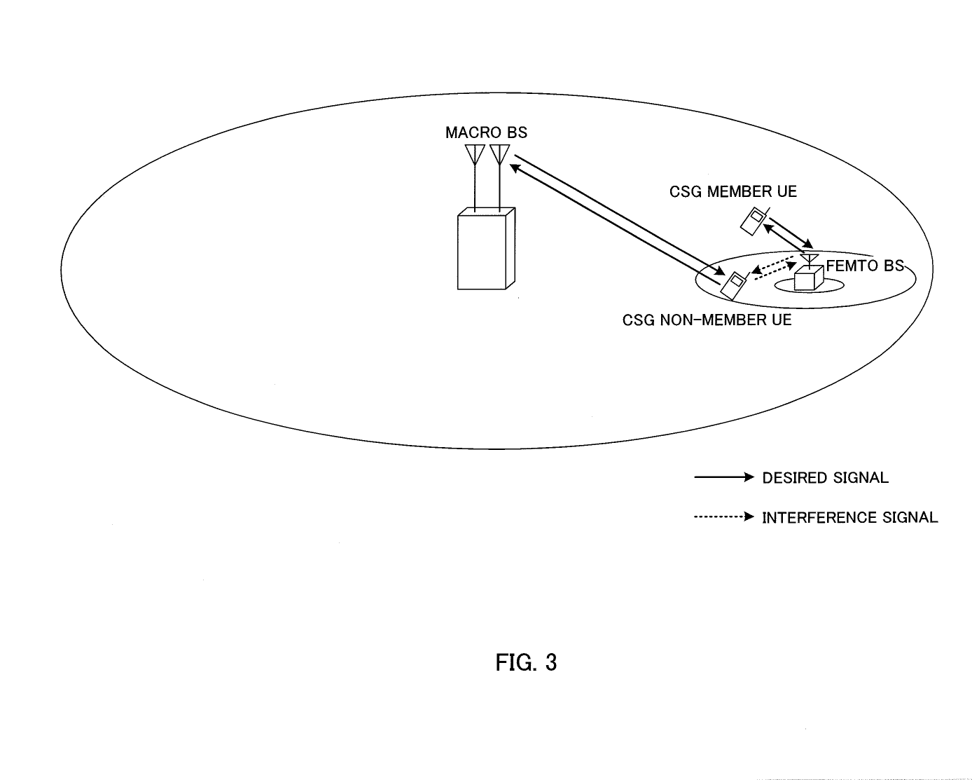

FIG. 4A and FIG. 4B are each a diagram for explaining a method of reducing interference of a non-CSG member UE;

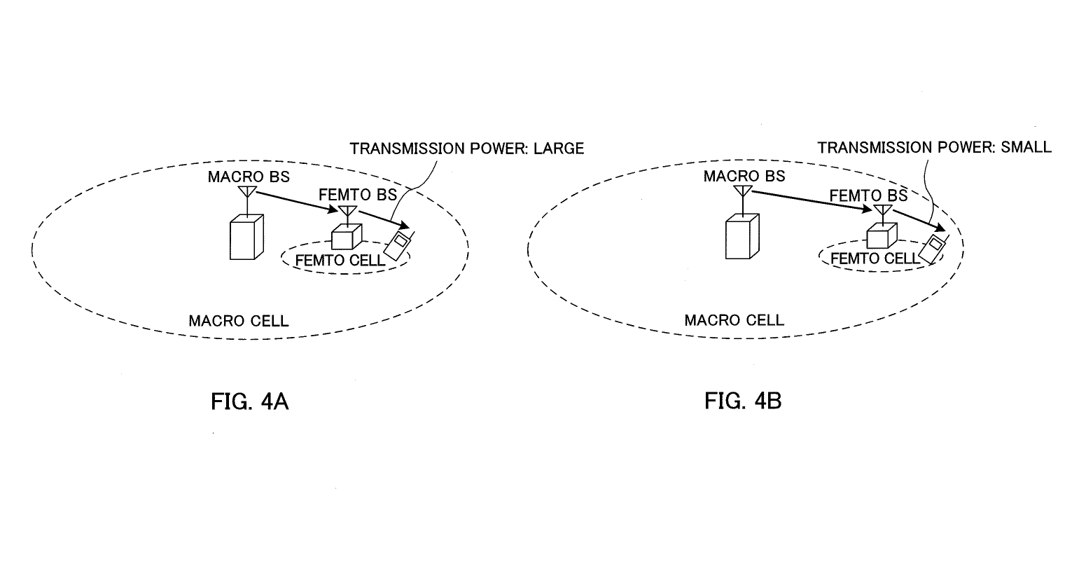

FIG. 5A to FIG. 5D are each a diagram for explaining a method of reducing interference of a non-CSG member UE;

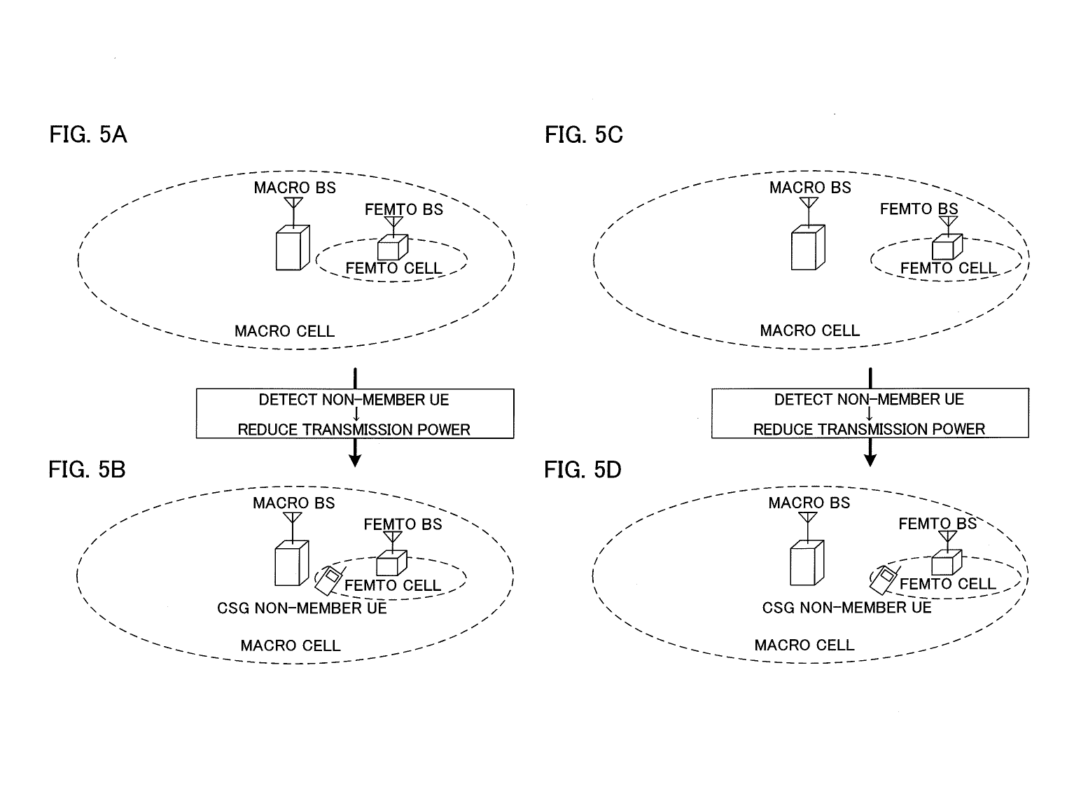

FIG. 6 is a diagram for explaining a transmission power control method according to an embodiment of the present invention;

FIG. 7 is a sequence diagram for explaining a transmission power control method according to an embodiment of the present invention;

FIG. 8 is a block diagram for explaining a configuration of a radio base station apparatus according to an embodiment of the present invention; and

FIG. 9 is a block diagram for explaining a configuration of a mobile terminal apparatus that communicates with a radio base station apparatus according to an embodiment of the present invention.

### DESCRIPTION OF EMBODIMENTS

Now, embodiments of the present invention will be described below in detail with reference to the accompanying drawings. The present inventors have focused on the fact that a mobile terminal apparatus reports received quality—for example, a measurement result of received power—to a radio base station apparatus as “measurement,” and, found out that, by using this received quality measurement result and accessibility information (information as to whether or not access to the radio base station apparatus of a femto cell is allowed (member/non-member)) and determining whether or not a non-CSG member mobile terminal apparatus has come near the femto cell and reporting the determined result to the radio base station apparatus of the femto cell, in the femto cell, it is possible to reduce interference of the non-CSG member mobile terminal apparatus, without constantly detecting whether or not a non-CSG member mobile terminal apparatus is in the cell, and arrived at the present invention.

That is to say, a summary of the present invention is that the radio base station apparatus of a macro cell receives registration information as to whether or not a mobile terminal apparatus is a non-member mobile terminal apparatus, which is not a mobile terminal apparatus having registered access to the radio base station apparatus of a femto cell, the received quality measurement result, and cell information, determines whether or not a non-member mobile terminal apparatus has come near the femto cell from the registration information, the received quality measurement result, and the cell information, and reports neighbor information, which indicates that a non-member mobile terminal apparatus has come near the femto cell, to the radio base station apparatus of the femto cell by a backhaul link, and the radio base station apparatus of the femto cell reduces the transmission power based on the neighbor information, so that, in the femto cell, it is possible to reduce interference of a non-CSG member mobile terminal apparatus without constantly detecting whether or not a non-CSG member UE is in the cell.

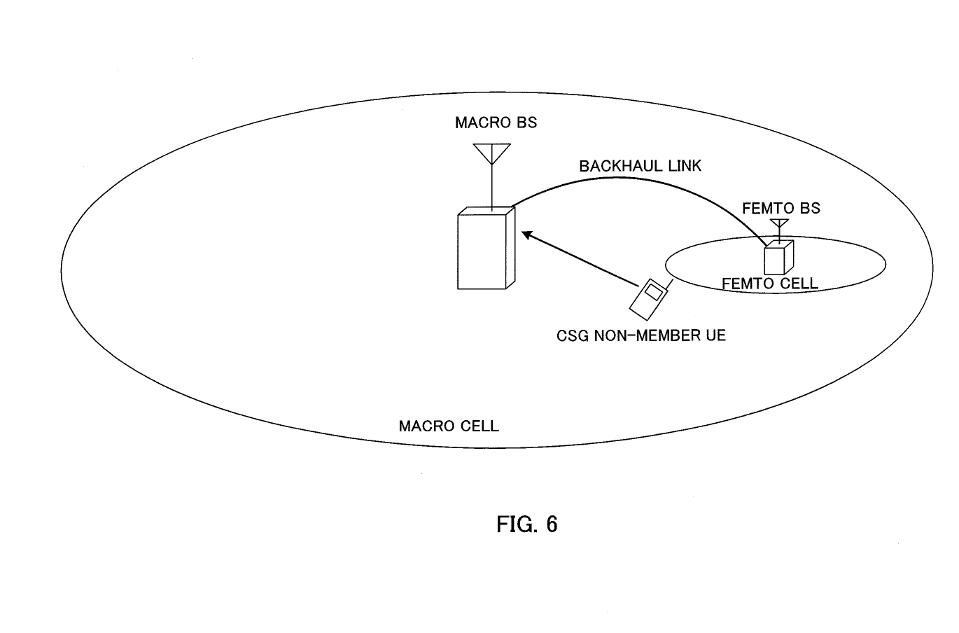

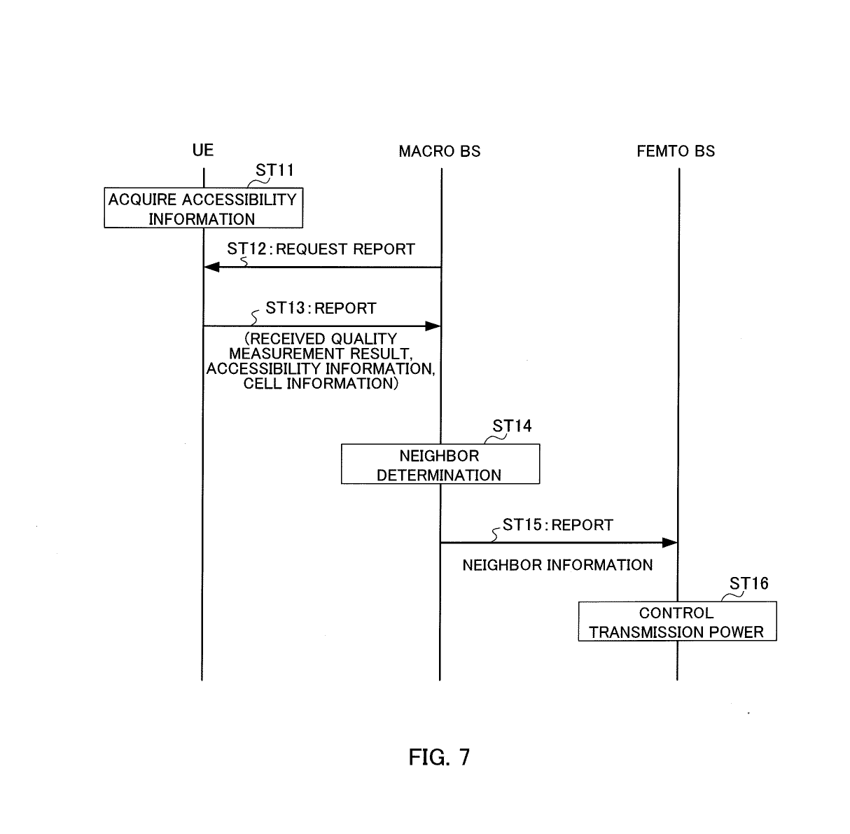

FIG. 6 is a diagram for explaining a transmission power control method according to an embodiment of the present invention, and FIG. 7 is a sequence diagram for explaining a transmission power control method according to an embodiment of the present invention. As shown in FIG. 6, HetNet is a layered network in which a femto cell is overlaid upon a macro cell. In this HetNet, a macro base station (macro BS), which is the radio base station apparatus of the macro cell, and a femto base station (femto BS), which is the radio base station apparatus of the femto cell, are included.

With the transmission power control according to the present invention, when a mobile terminal satisfies the condition reported from the macro BS (for example, the received quality of another cell becomes better than that of the connecting cell), a received quality measurement result (measurement), and cell information such as the cell number (cell ID) of the base station where better received quality than the connecting cell is detected, are reported to the macro base station. The mobile terminal is able to recognize whether or not the cell is a femto cell, from the cell information. When the cell is a femto cell, the mobile terminal determines registration information (accessibility information) as to whether the mobile terminal can access—that is, whether or not the mobile terminal is a mobile terminal having registered access to the femto base station (CSG-member UE/non-CSG member UE)—and reports the result, with the received quality measurement result, to the macro base station.

That is to say, the mobile terminal is able to identify a femto cell from the cell ID of the cell where received quality is measured. Then, the mobile terminal is able to recognize whether or not the mobile terminal is able to access the femto base station from broadcast information of the femto cell (whether the mobile terminal is a CSG-member UE or a non-CSG member UE) (acquisition of accessibility information: ST 11).

The macro base station requests a measurement report to the mobile terminal (ST 12), and the mobile terminal reports a measurement (received quality measurement result) to the macro base station (ST 13). Then, the mobile terminal reports cell information (ID), and, if necessary, accessibility information, to the macro base station (ST 13), with the measurement.

The macro base station determines whether or not a non-CSG member UE has come near the femto cell (neighbor determination) (ST 14). Normally, the macro base station performs this operation when carrying out a handover process using the measurement reported from the mobile terminal. Then, the macro base station receives accessibility information (registration information) from the mobile terminal, and therefore is able to know whether the mobile terminal, from which the report is received, is able to access the femto base station (whether the mobile terminal is a CSG-member UE or a non-CSG member UE). In this way, the macro base station is able to determine whether or not a non-CSG member UE has come near the femto cell, from the accessibility information, received quality and the cell information. Note that the mobile terminal is able to acquire registration information (accessibility information) as to whether the mobile terminal is a CSG-member UE or a non-CSG member UE, from broadcast information.

When a non-CSG member UE comes near the femto cell, the macro base station reports neighbor information, which indicates that a non-CSG member UE has come near the femto cell, to the femto base station (ST 15). In this case, this neighbor information is reported to the femto base station by a backhaul link (for example, an X2 interface). The femto base station controls (reduces) transmission power based on the neighbor information (ST 16). The macro base station may as well report the measurement, with the neighbor information, to the femto base station, by the backhaul link. Note that the neighbor information may include a command to reduce transmission power.

In the transmission power control at the femto base station, transmission power may be reduced to a certain level regardless of the received quality measurement result, or transmission power may be reduced according to the received quality measurement result. Note that transmission power may be determined using the received quality measurement result.

When detecting that a non-CSG member UE has left the femto cell, the macro base station determines, using the measurement (received quality measurement result), as when detecting whether a non-CSG member UE has come near the femto cell. For example, in the macro base station, when the measurement of the macro base station becomes greater than the measurement of the femto base station, neighbor information to indicate that a non-CSG member UE has left the femto cell, to the femto base station. Then, at the femto base station, transmission power is increased (back to the original transmission power). Note that the neighbor information may include a command to increase transmission power (back to the original transmission power).

Alternatively, without reporting neighbor information from the macro base station, at the femto base station, transmission power is reduced, and, after a predetermined period passes, transmission power is increased (back to the original transmission power). In this case, the predetermined period is measured using a timer, for example. In this case, if, after transmission power is reduced, and, a predetermined period later, increased (back to the original transmission power), neighbor information to indicate that a non-CSG member UE has come near the femto cell is received again, the length of the predetermined period is changed (made longer, for example). Also, if, after transmission power is increased (back to the original transmission power) a predetermined period later, neighbor information to indicate that a non-CSG member UE has come near the femto cell is not received again, the length of the predetermined period is changed (made shorter, for example). By executing such control, it is possible to control the period adaptively.

In this way, with the transmission power control of the present invention, whether a non-CSG member UE has come near the femto cell is determined utilizing a measurement report from the mobile terminal, which is given normal operations, so that, in the femto cell, it is possible to reduce interference of a non-CSG member mobile terminal apparatus, without constantly detecting whether a non-CSG member mobile terminal apparatus is in the cell.

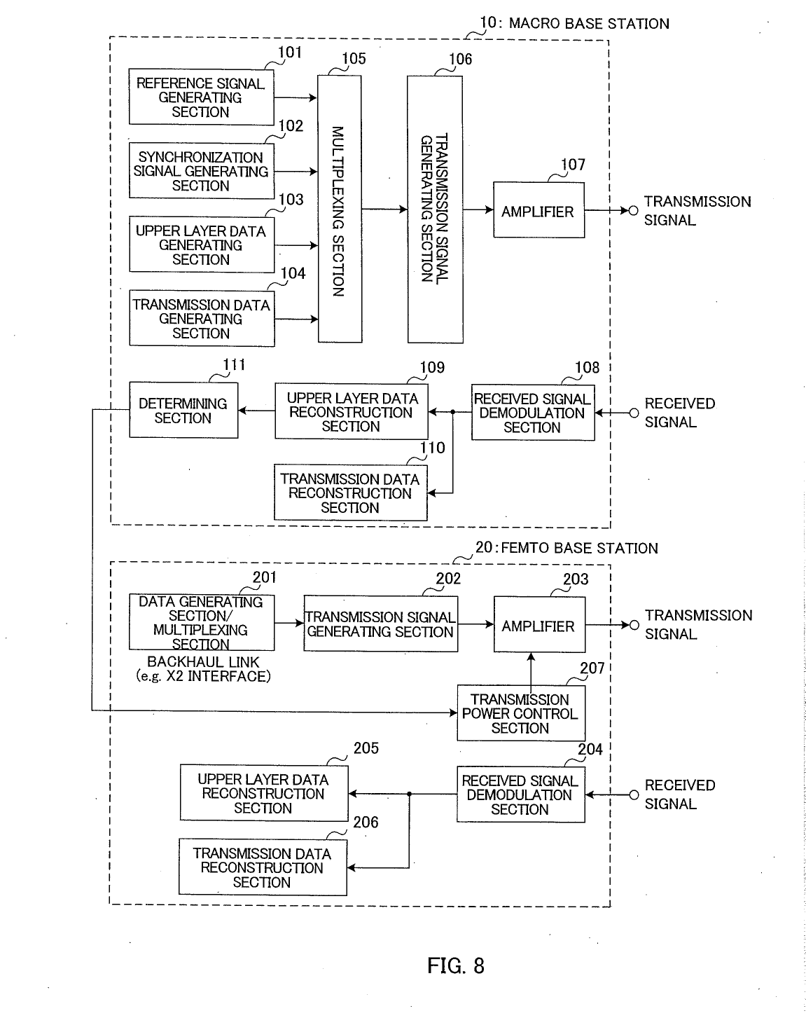

FIG. 8 is a block diagram for explaining a configuration of a radio base station apparatus according to an embodiment of the present invention. The radio base station apparatus of HetNet shown in FIG. 8 has a macro base station 10, which is the radio base station apparatus of the macro cell, and a femto base station 20, which is the radio base station apparatus of the femto cell. The macro base station 10 and the femto base station 20 are connected by a backhaul link such as an X2 interface.

The transmitting system of the macro base station 10 is primarily formed with a reference signal generating section 101, a synchronization signal generating section 102, an upper layer data generating section 103, a transmission data generating section 104, a multiplexing section 105, a transmission signal generating section 106, and an amplifier 107. The receiving system of the macro base station 10 is primarily formed with a received signal demodulation section 108, an upper layer data reconstruction section 109, a transmission data reconstruction section 110, and a determining section 111.

The reference signal generating section 101 generates a reference signal for measuring received quality in a mobile terminal. The reference signal generating section 101 outputs the reference signal to the multiplexing section 105. The synchronization signal generating section 102 generates a synchronization signal for detecting cell ID in the mobile terminal. The synchronization signal generating section 102 outputs the synchronization signal to the multiplexing section 105. The upper layer data generating section 103 generates upper layer data, which is, for example, data to request reporting of a measurement (received quality measurement result), and data to represent the measurement method (for example, reporting when the received quality from another cell becomes better than that of the connecting cell). The upper layer data generating section 103 outputs such upper layer data to the multiplexing section 105. The transmission data generating section 104 generates data to transmit to the mobile terminal. The transmission data generating section 104 outputs the transmission data to the multiplexing section 105.

The multiplexing section 105 multiplexes the reference signal, the synchronization signal, the upper layer data and the transmission data, and provides a multiplex signal. The multiplexing section 105 outputs the multiplex signal to the transmission signal generating section 106. The transmission signal generating section 106 applies predetermined signal processing to the multiplex signal and generates a transmission signal. The transmission signal is amplified in the amplifier 107 and then transmitted to the mobile terminal 30 as a downlink signal.

The received signal demodulation section 108 receives an uplink signal from the mobile terminal 30, and demodulates the received signal. The received signal demodulation section 108 outputs the signal after the demodulation (demodulated signal) to the upper layer data reconstruction section 109 and the transmission data reconstruction section 110. The received signal includes registration information as to whether or not a mobile terminal apparatus is a non-member mobile terminal apparatus, which is not a mobile terminal apparatus having registered access to the femto base station (registration information whether or not access to the femto base station is allowed), a measurement (received quality measurement result), and cell information such as cell IDs.

The upper layer data reconstruction section 109 extracts and reconstructs the upper layer data from the demodulated signal. This upper layer data includes a measurement (received quality measurement result), cell information such as cell IDs and so on, and registration information as to whether or not access to the femto base station is allowed (registration information as to whether the mobile terminal is a CSG-member UE or a non-CSG member UE) (accessibility information). The upper layer data reconstruction section 109 outputs the reconstructed upper layer data to the determining section 111. The transmission data reconstruction section 110 extracts and reconstructs the transmission data from the demodulated signal.

The determining section 111 determines whether or not a non-CSG member UE has come near the femto cell. That is to say, using the measurement, which is upper layer data, the determining section 111 determines which cell shows a greater measurement than the measurement of the connecting cell, and determines whether a cell having a greater measurement than the measurement of the connecting cell is a femto cell, from the cell information, which is upper layer data. Furthermore, the determining section 111 finds out whether or not the mobile terminal, from which the report is received, can access the femto base station (whether the mobile terminal is a CSG-member UE or a non-CSG member UE), from the accessibility information (registration information), which is upper layer data. In this way, the determining section 111 determines whether or not a non-CSG member UE has come near femto cell, from the accessibility information, the measurement and the cell information. The determining section 111, upon determining that a non-CSG member UE has come near the femto cell, reports neighbor information to indicate that a non-CSG member UE has come near the femto cell, to the femto base station 20, via a backhaul link.

Also, the determining section 111 may as well determine whether or not a non-CSG member UE has left the femto cell. In this case, the determination is made using the measurement (received quality measurement result), as when detecting that a non-CSG member UE has come near the femto cell. For example, at the macro base station, when the measurement of the macro base station becomes greater than the measurement of the femto base station, neighbor information to indicate that a non-CSG member UE has left the femto cell is reported to the femto base station 20, via a backhaul link.

The transmitting system of the femto base station 20 is primarily formed with a data generating section/multiplexing section 201, a transmission signal generating section 202, an amplifier 203 and a transmission power control section 207. The receiving system of the femto base station 20 is primarily formed with a received signal demodulation section 204, an upper layer data reconstruction section 205, and a transmission data reconstruction section 206.

The data generating section/multiplexing section 201 generates a reference signal for measuring received quality in a mobile terminal, a synchronization signal for detecting cell IDs in the mobile terminal, and upper layer data, which is, for example, data to request reporting of a measurement (received quality measurement result), data to represent the measurement method, and so on. The upper layer data and the data to transmit to the mobile terminal are generated, and these signals are multiplexed to provide a multiplex signal. The data generating section /multiplexing section 201 outputs the multiplex signal to the transmission signal generating section 202.

The transmission signal generating section 202 applies predetermined signal processing to the multiplex signal and generates a transmission signal. The transmission signal is amplified in the amplifier 203 and then transmitted to the mobile terminal 30 as a downlink signal.

The transmission power control section 207 controls transmission power in accordance with a command from the macro base station 10 (controls the amplification factor of the amplifier 203). That is to say, upon receiving neighbor information to indicate that a non-CSG member UE, which is not a CSG-member UE having registered access to the femto base station 20, has comes near, from the macro base station 10, the transmission power control section 207 reduces transmission power based on the neighbor information (reduces the amplification factor of the amplifier 203). Upon receiving the neighbor information, the transmission power control section 207 reduces transmission power to a certain level regardless of the measurement (received quality measurement result), or reduces transmission power in accordance with the measurement.

Also, upon receiving neighbor information which indicates that a non-CSG member UE has left the femto cell, from the macro base station 10, the transmission power control section 207 increases transmission power (back to the original transmission power) based on the neighbor information (increases the amplification factor of the amplifier 203). Alternatively, when neighbor information to indicate that a non-CSG member UE has left the femto cell is not reported from the macro base station 10, the transmission power control section 207 reduces transmission power, and, after a predetermined period passes, increases the transmission power (back to the original transmission power). In this case, if, after transmission power is reduced, and, a predetermined period later, increased (back to the original transmission power), neighbor information to indicate that a non-CSG member UE has come near the femto cell is received again, the length of the predetermined period is changed (made longer, for example).

The received signal demodulation section 204 receives the uplink signal from the mobile terminal 30 and demodulates the received signal. The received signal demodulation section 204 outputs the signal after the demodulation (demodulated signal) to the upper layer data reconstruction section 205 and the transmission data reconstruction section 206.

The upper layer data reconstruction section 205 extracts and reconstructs the upper layer data from the demodulated signal. This upper layer data includes a measurement (received quality measurement result), and cell information such as cell IDs. The transmission data reconstruction section 206 extracts and reconstructs transmission data from the demodulated signal.

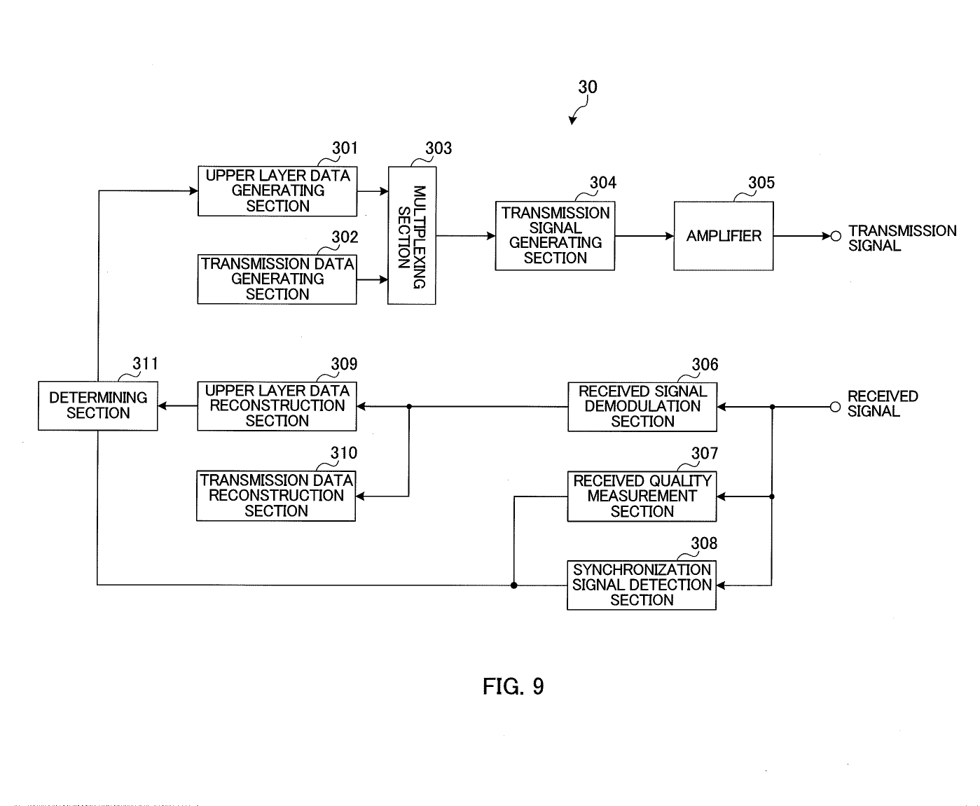

FIG. 9 is a block diagram for explaining the configuration of a mobile terminal apparatus that communicates with a radio base station apparatus according to an embodiment of the present invention. The transmitting system of the mobile terminal shown in FIG. 9 is primarily formed with an upper layer data generating section 301, a transmission data generating section 302, a multiplexing section 303, a transmission signal generating section 304 and an amplifier 305. The receiving system of the mobile terminal is primarily formed with a received signal demodulation section 306, a received quality measurement section 307, a synchronization signal detection section 308, an upper layer data reconstructing section 309, a transmission data reconstructing section 310 and a determining section 311.

The upper layer data generating section 301 generates upper layer data including, for example, registration information as to whether or not a mobile terminal apparatus is a non-member mobile terminal apparatus, which is not a mobile terminal apparatus having registered access to the femto base station (registration information whether or not access to the femto base station is allowed), a measurement (received quality measurement result), and cell information such as cell IDs. The upper layer data generating section 301 outputs such upper layer data to the multiplexing section 303. The transmission data generating section 302 generates the data to transmit to the macro base station 10 and the femto base station 20. The transmission data generating section 302 outputs the transmission data to the multiplexing section 303.

The multiplexing section 303 multiplexes the upper layer data and the transmission data and provides a multiplex signal. The multiplexing section 303 outputs the multiplex signal to the transmission signal generating section 304. The transmission signal generating section 304 applies predetermined signal processing to the multiplex signal and generates a transmission signal. The transmission signal is amplified in the amplifier 305 and then transmitted to the macro base station 10 and the femto base station 20 as an uplink signal.

The received signal demodulation section 306 receives the downlink signal from the macro base station 10 and the femto base station 20 and demodulates the received signal. The received signal demodulation section 306 outputs the signal after the demodulation (demodulated signal) to the upper layer data reconstructing section 309 and the transmission data reconstructing section 310. The received signal includes upper layer data, which is, for example, data to request reporting of a measurement (received quality measurement result), and data to represent the measurement method.

The received quality measurement section 307 measures received quality (for example, received power) using the reference signal included in the downlink signal. This measurement result (measurement) of received quality is transmitted to the macro base station 10 and the femto base station 20 as upper layer data.

The synchronization signal detection section 308 identifies the cell ID using the synchronization signal included in the downlink signal. The result of this cell ID identification (cell information) is transmitted to the macro base station 10 and the femto base station 20 as upper layer data.

The upper layer data reconstructing section 309 extracts and reconstructs the upper layer data from the demodulated signal. The upper layer data includes, for example, data to request a measurement (received quality measurement result) and data to represent the measurement method. The upper layer data reconstructing section 309 outputs the upper layer data to the determining section 311. The transmission data reconstructing section 310 extracts and reconstructs the transmission data from the demodulated signal.

Based on the measurement method, the determining section 311 determines to report, if necessary, the cell ID and the received quality measurement result, in the upper layer. That is to say, the determining section 311 determines whether or not it is necessary to report the measurement and the cell ID, and, upon determining that it is necessary, commands the upper layer data generating section 301 to report the measurement (received quality measurement result), cell ID and registration information (accessibility information) to the macro base station 10.

In the radio communication system of this configuration, the macro base station 10 receives registration information as to whether a mobile terminal is a non-CSG member UE, which is not a CSG-member UE having registered access to the femto base station, a measurement (received quality measured result), and cell information, and the determining section 111 determines whether or not a non-CSG member UE has come near the femto cell from the registration information, the measurement and the cell information. When it is determined that a non-CSG member UE has come near the femto cell, neighbor information to indicate that a non-CSG member UE has come near the femto cell is reported to the femto base station, by a backhaul link. The femto base station reduces transmission power based on the neighbor information.

Also, in the radio communication system of the above configuration, when neighbor information to indicate that the non-CSG member UE has left the femto cell is received from the macro base station 10, transmission power is increased (back to the original transmission power) based on the neighbor information (the amplification factor of the amplifier 203 is increased). In this case, when the measurement of the macro base station 10 becomes greater than the measurement of the femto base station 20, the determining section 111 of the macro base station 10 reports neighbor information to indicate that a non-CSG member UE has left the femto cell, to the femto base station 20.

Alternatively, when neighbor information to indicate that a non-CSG member UE has left the femto cell is not reported from the macro base station 10, the transmission power control section 207 reduces transmission power and, after a predetermined period passes, increases transmission power (back to the original transmission power). In this case, if, after transmission power is reduced, and, a predetermined period later, increased (back to the original transmission power), neighbor information to indicate that a non-CSG member UE has come near the femto cell is received again, the length of the predetermined period is changed (made longer, for example).

In this way, according to the present invention, transmission power is not unnecessarily reduced when there is no CSG non-member UE in the femto cell, and, furthermore, in the femto cell, it is possible to reduce interference of a CSG non-member mobile terminal apparatus without constantly detecting whether or not a CSG non-member UE is in the cell.

Although the present invention has been described in detail with reference to the above embodiments, it should be obvious to a person skilled in the art that the present invention is by no means limited to the embodiments described in this specification. The present invention can be implemented with various corrections and in various modifications, without departing from the spirit and scope of the present invention defined by the recitations of the claims. Consequently, the descriptions in this specification are provided only for the purpose of explaining examples, and should by no means be construed to limit the present invention in any way.

### INDUSTRIAL APPLICABILITY

The present invention is suitable for use for a radio base station apparatus and a transmission power control method in an LTE-A system.

The disclosure of Japanese Patent Application No. 2010-174372, filed on Aug. 3, 2010, including the specification, drawings, and abstract, is incorporated herein by reference in its entirety.

1. A radio base station apparatus of a macro cell in a heterogeneous network including the macro cell and a femto cell, the radio base station apparatus comprising:
a receiving section that receives registration information as to whether or not a mobile terminal apparatus is a non-member mobile terminal apparatus, which is not a mobile terminal apparatus having registered access to a radio base station apparatus of the femto cell, a received quality measurement result, and cell information;
a determining section that determines whether or not the non-member mobile terminal apparatus has come near the femto cell from the registration information, the received quality measurement result, and the cell information; and
a reporting section that reports neighbor information, which indicates that the non-member mobile terminal apparatus has come near the femto cell, to the radio base station apparatus of the femto cell, by a backhaul link.

2. The radio base station apparatus according to claim 1, wherein the reporting section reports the received quality measurement result to the radio base station apparatus of the femto cell by the backhaul link.

3. The radio base station apparatus according to claim 1, wherein the determining section determines that the non-member mobile terminal apparatus has left the femto cell, from the received quality measurement result.

4. A radio base station apparatus of a femto cell in a heterogeneous network including a macro cell and the femto cell, the radio base station apparatus comprising:
a transmission signal generating section that generates a transmission signal; and
a transmission power control section that, when receiving neighbor information which indicates that a non-member mobile terminal apparatus, which is not a mobile terminal apparatus having registered access to the radio base station apparatus of the femto cell, from a radio base station apparatus of the macro cell, reduces transmission power of the transmission signal based on the neighbor information.

5. The radio base station apparatus according to claim 4, wherein, the transmission power control section, when receiving the received quality measurement result of the mobile terminal apparatus from the radio base station apparatus of the macro cell by the backhaul link, reduces the transmission power of the transmission signal in accordance with the received quality measurement result.

6. The radio base station apparatus according to claim 4, wherein the transmission power control section reduces the transmission power of the transmission signal, and, after a predetermined period passes, increases the transmission power.

7. The radio base station apparatus according to claim 6, wherein, when the neighbor information is received after the transmission power is increased, the transmission power control section changes a length of the predetermined period.

8. A transmission power control method in a heterogeneous network including a macro cell and a femto cell, the transmission power control method comprising the steps of:
in a radio base station apparatus of the macro cell:
receiving registration information as to whether or not a mobile terminal apparatus is a non-member mobile terminal apparatus, which is not a mobile terminal apparatus having registered access to a radio base station apparatus of the femto cell, a received quality measurement result, and cell information;
determining whether or not the non-member mobile terminal apparatus has come near the femto cell from the registration information, the received quality measurement result, and the cell information; and
reporting neighbor information, which indicates that the non-member mobile terminal apparatus has come near the femto cell, to the radio base station apparatus of the femto cell, by a backhaul link; and
in the radio base station apparatus of the femto cell:
generating a transmission signal; and
reducing transmission power of the transmission signal based on the neighbor information.

9. The transmission power control method according to claim 8, wherein the radio base station apparatus of the macro cell reports the received quality measurement result to the radio base station apparatus of the femto cell by the backhaul link.

10. The transmission power control method according to claim 8, wherein the radio base station apparatus of the macro cell determines that the non-member mobile terminal apparatus has left the femto cell from the received quality measurement result.

11. The transmission power control method according to claim 9, wherein the radio base station apparatus of the femto cell reduces the transmission power of the transmission signal in accordance with the received quality measurement result from the radio base station apparatus of the macro cell.

12. The transmission power control method according to claim 8, wherein the radio base station apparatus of the femto cell reduces the transmission power of the transmission signal, and, after a predetermined period passes, increases the transmission power.

13. The transmission power control method according to claim 12, wherein, when the neighbor information is received after the transmission power of the transmission signal is increased, the radio base station apparatus of the femto cell changes a length of the predetermined period.

14. The radio base station apparatus according to claim 2, wherein the determining section determines that the non-member mobile terminal apparatus has left the femto cell, from the received quality measurement result.

15. The radio base station apparatus according to claim 5, wherein the transmission power control section reduces the transmission power of the transmission signal, and, after a predetermined period passes, increases the transmission power.

16. The transmission power control method according to claim 9, wherein the radio base station apparatus of the macro cell determines that the non-member mobile terminal apparatus has left the femto cell from the received quality measurement result.
